(19) United States
(12) Patent Application Publication
(10) Pub. No.: US 2007/0021985 A1
(43) Pub. Date: Jan. 25, 2007

(54) Uninsured cost estimation system and method

(75) Inventors: William C. Reynolds, Western Springs, IL (US); William Morrisett, Palatine, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: CompEraser, Inc.

(21) Appl. No.: 11/187,231

(22) Filed: Jul. 22, 2005

(51) Int. Cl. G06Q 40/00

(52) U.S. Cl. 705/4

(57) ABSTRACT

An uninsured cost estimation system comprises a database for storing estimated cost factors for uninsured costs related to worker's compensation claims. A user work station is provided for entering claim data relating to an injured employee including work status information selected from lost work time, restricted duty work time, job transfer time and return to work. A programmed processing system is operatively connected to the database and communicates with the user work station over a network. The programmed processing system operates in accordance with a program to estimate uninsured costs comprising determining durations of the work status information from the claim data and calculating costs of a claim by applying the estimated cost factors to the duration of work status to estimate uninsured costs for the injured employee.

### FIELD OF THE INVENTION

This invention relates to a system and method for estimating uninsured costs for an injured employee.

### BACKGROUND OF THE INVENTION

Many companies, while navigating the choppy waters of worker's compensation, fail to see that accident costs are similar to an iceberg. Part of the iceberg that is visible corresponds to the direct “insured costs” of an injury claim. However, there are frequently larger, indirect “uninsured costs” that remain hidden beneath the surface. It is the uninsured costs that can prove expensive to the company's bottom line.

Workplace accidents have obvious direct financial ramifications. These include medical, hospital and rehabilitation expenses. Also, higher insurance premiums may result or, in some cases, a total loss of insurability. There are many indirect costs that are usually uninsured yet can seriously effect a company's bottom line profits. Examples of these indirect costs include time lost from work by an injured employee, damage to company morale, costs of training new employees, loss of production, and possible damage to equipment. It has been suggested that the uninsured costs of workplace injuries, i.e., costs usually not covered by insurance, can range anywhere from two to ten times the cost of the face value of a claim.

When a worker is injured on the job, regardless of whether the claim is a medical only or lost time claim, other employees will have time away from their normal business duties to respond to the event. This is a direct loss of productivity. Examples of such a situation include a supervisor taking time to respond to an employee's injury. The employee will be given first aid treatment or taken to an occupational clinic. The supervisor will typically complete an accident investigation report. A claim coordinator will complete necessary paper work to report the injury to an insurance company and also ascertain the nature of the employee's injury and return-to-work status. Other employees in the department may lose time commiserating about the injury. A safety committee and upper management may get involved to review a claim and take action to avoid its recurrence. Finally, if the employee is disabled and unable to return to work, there are a host of activities that must be considered to address on-going production.

The present invention is directed to solving one or more of the problems discussed above.

### SUMMARY OF THE INVENTION

In accordance with the invention, there is provided a system and method for estimating uninsured costs for an injured employee.

Broadly, there is disclosed in accordance with one aspect of the invention an uninsured cost estimation method comprising: storing a database of estimated cost factors for uninsured costs related to worker's compensation claims; entering claim data relating to an injured employee including work status information selected from lost work time, restricted duty work time, job transfer time and return to work; and operating a processing system to estimate insured costs comprising determining durations of the work status information from the claim data and calculating costs of a claim by applying the estimated cost factors to the durations of work status to estimate uninsured costs for the insured employee.

It is a feature of the invention that the estimated cost factors are selected from the group consisting of employee average compensation rate, worker compensation parameters, uninsured costs of medical claims, uninsured costs of lost time for a claim, lost time costs for a select time period, and variable uninsured costs of a lost time claim.

It is another feature of the invention to generate a report showing the estimated uninsured costs for the injured employee.

It is still a further feature in the invention that entering claim data relating to an injured employee further comprises entering insured cost amounts for the injured employee.

It is yet a further feature of the invention to generate a report showing total worker injury costs for the injured employee including insured cost amounts and the estimated insurance costs.

It is still another feature of the invention that claim data is entered on a remote processor connected to the processing system via a network.

It is still another feature of the invention that the database of estimated cost factors for uninsured costs related to worker compensation claims comprises a plurality of tables for different locations and years.

It is still another feature of this invention that a Best Practice Report can be created that analyzes and benchmarks the effectiveness of responding to a worker injury in the first 48 hours. It has been proven that such a prompt response, if done properly, will dramatically reduce the total cost of worker injuries.

It is still another feature of this invention that a Best Practice Report can be created that analyzes and benchmarks the effectiveness of disability management utilizing a temporary duty (return-to-work) program. It has been proven that such a disability management program will dramatically reduce the total cost of worker injuries.

There is disclosed in accordance with another aspect of the invention an uninsured cost estimation system comprising memory means for storing estimated cost factors for uninsured costs related to worker's compensation claims. Input means are provided for entering claim data relating to an injured employee including work status information selected from lost work time, restricted duty work time, job transfer time and return to work. A programmed processing system is associated with the memory means and the input means and is operated in accordance with a program to estimate uninsured costs comprising determining durations of the work status information from the claim data and calculating costs of a claim by applying the estimated cost factors to the durations of work status to estimate uninsured costs for the injured employee.

There is disclosed in accordance with yet another aspect of the invention an uninsured cost estimation system comprising a database for storing estimated cost factors for uninsured costs related to worker's compensation claims. A user work station is provided for entering claim data relating to an injured employee including work status information selected from lost work time, restricted duty work time, job transfer time and return to work. A programmed processing system is operatively connected to the database and communicates with the user work station over a network. The programmed processing system operates in accordance with a program to estimate uninsured costs comprising determining durations of the work status information from the claim data and calculating costs of a claim by applying the estimated cost factors to the duration of work status to estimate uninsured costs for the injured employee.

Further features and advantages of the invention will be readily apparent from the specification and from the drawings.

### BRIEF DESCRIPTION OF THE DRAWINGS

FIG. 1 is a block diagram of an uninsured cost estimation system in accordance with the invention; FIG. 2 is a block diagram listing top level agent functions and employer functions implemented in the web server of FIG. 1;

FIG. 3 is a more detailed block diagram of the employer functions of FIG. 2;

FIG. 4 illustrates tables stored in the database of FIGS. 2 and 3 and the relationship between these tables;

FIG. 5 is a flow diagram illustrating the uninsured cost estimation method in accordance with the invention implemented in the system of FIG. 1;

FIG. 6 is a flow diagram illustrating procedures for updating claim record cost fields as part of the flow diagram of FIG. 5;

FIG. 7 is a graphic screen display for an employer set up/maintenance routine of the uninsured cost estimation system and method in accordance with the invention;

FIG. 8 is a screen display for selecting worksheets for updating; and

FIG. 9 is a display for a report generated by the uninsured cost estimation system and method in accordance with the invention.

### DETAILED DESCRIPTION OF THE INVENTION

The present invention relates to an uninsured cost estimation method and system operating as a web-based tool designed to automate and manage worker's compensation claim management activities, develop credible financial data that will calculate total economic costs of worker injuries and provide reports and other resources to decrease total costs of worker injuries.

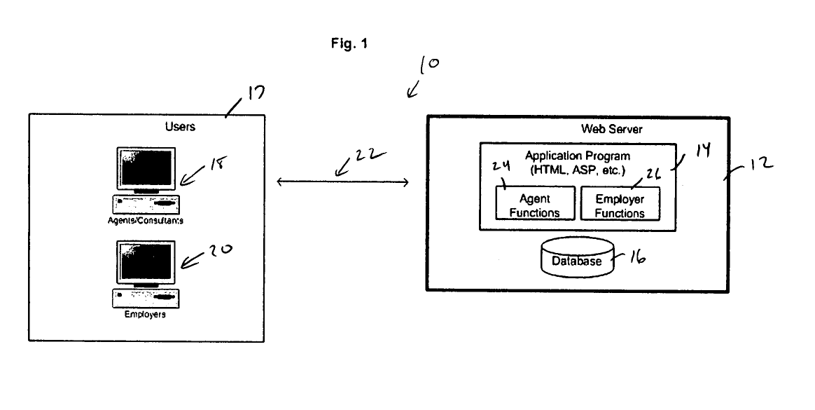

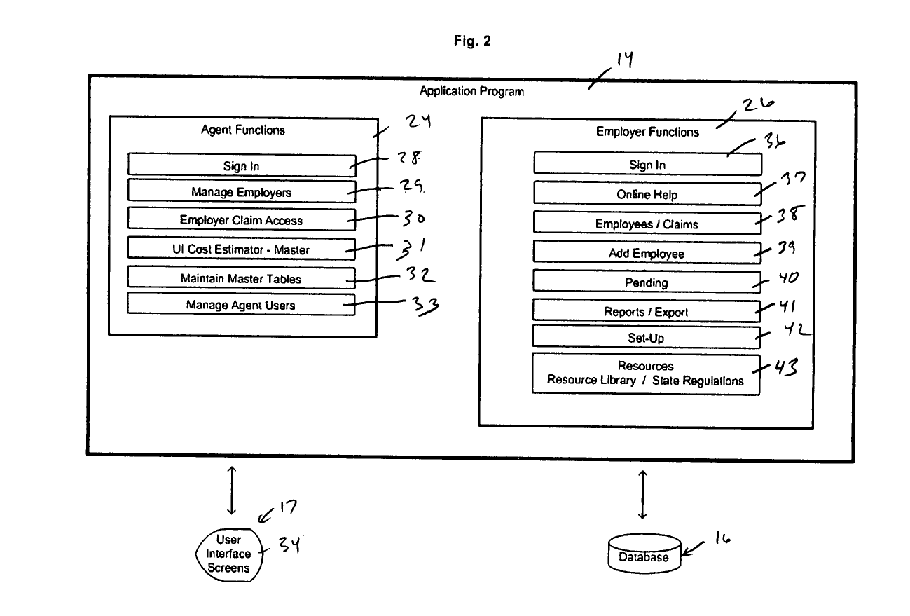

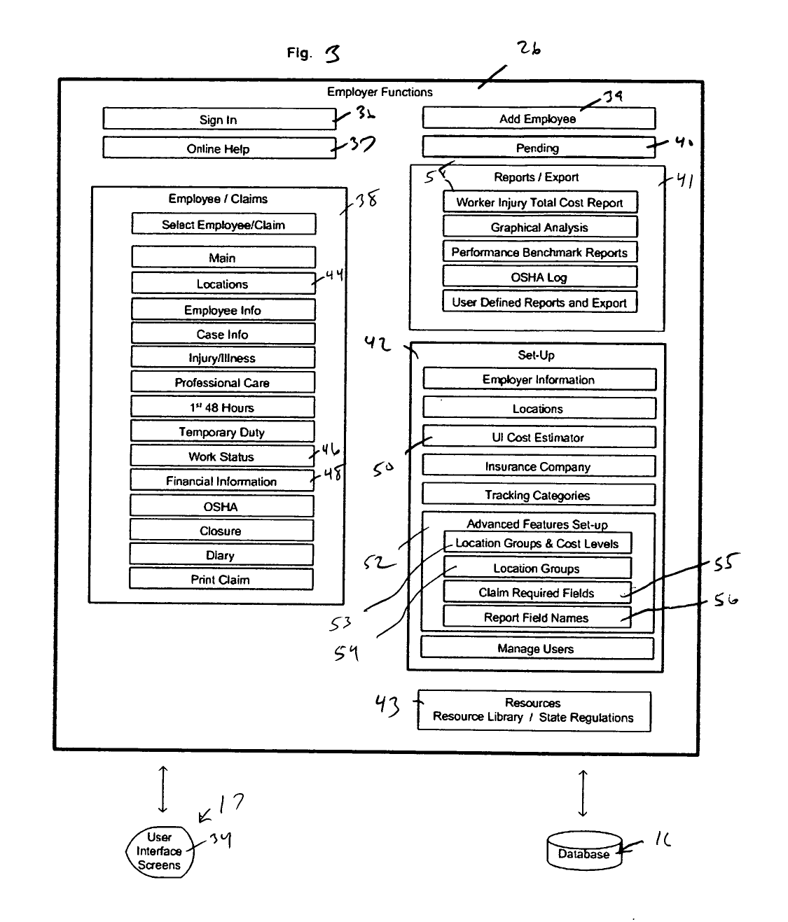

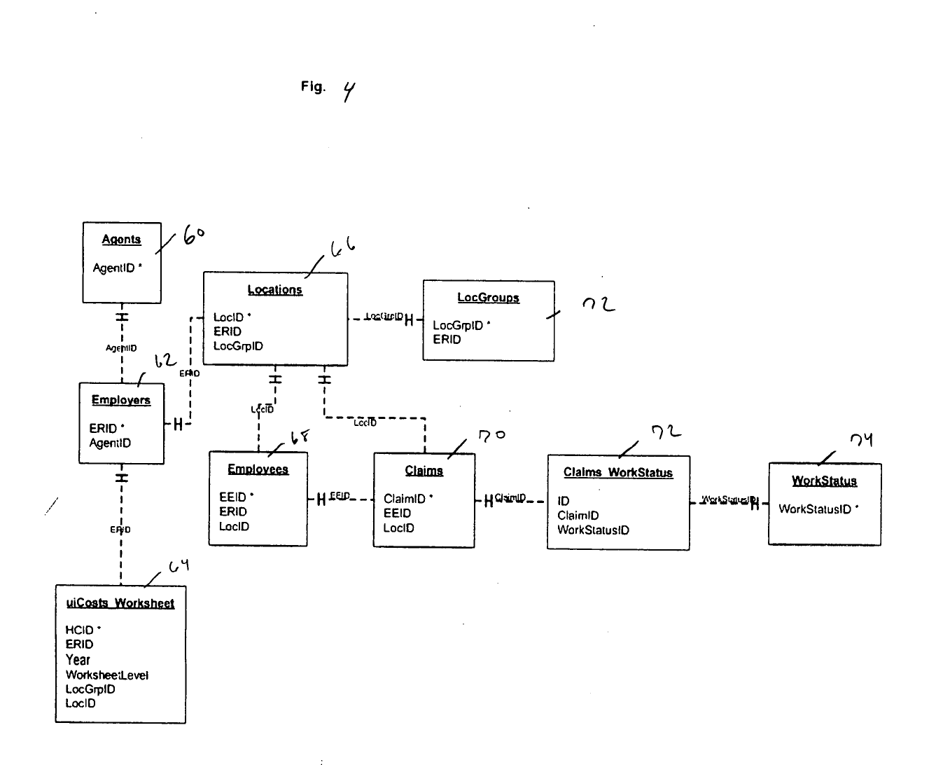

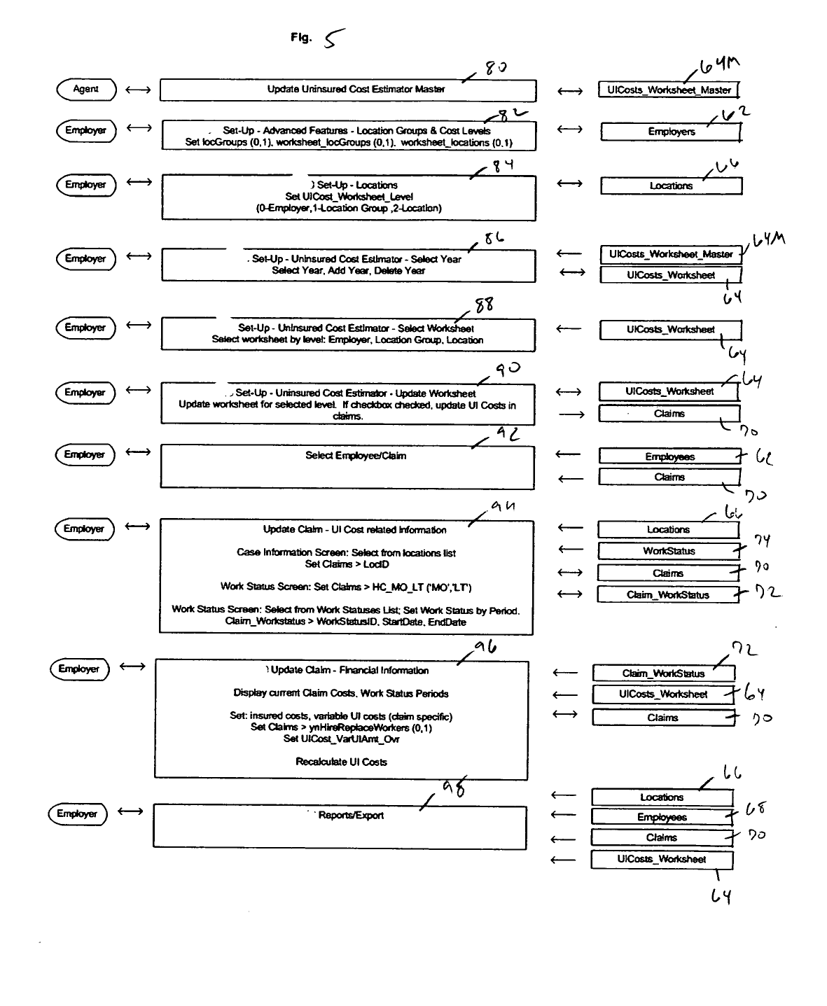

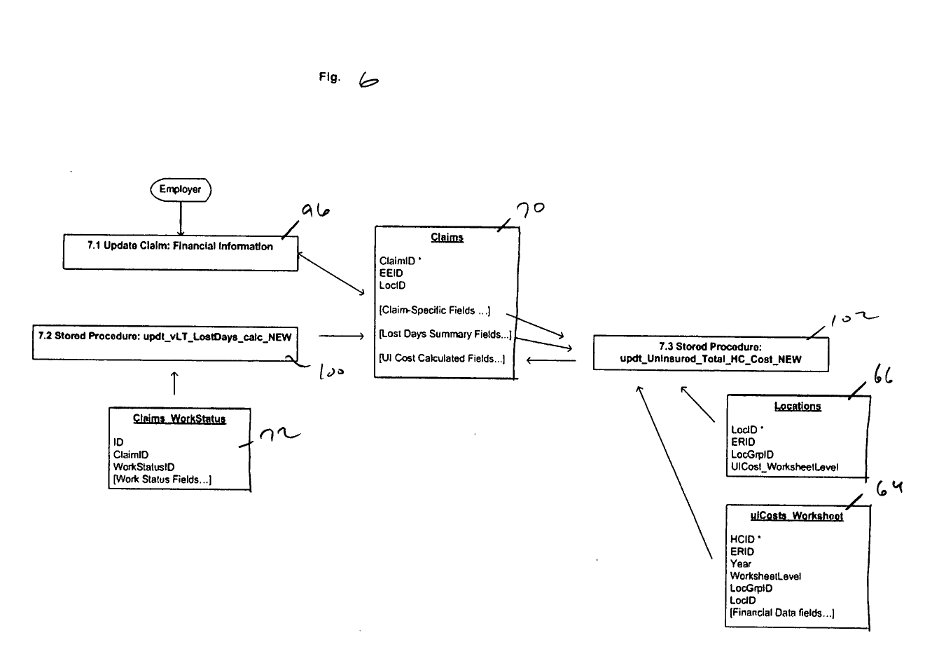

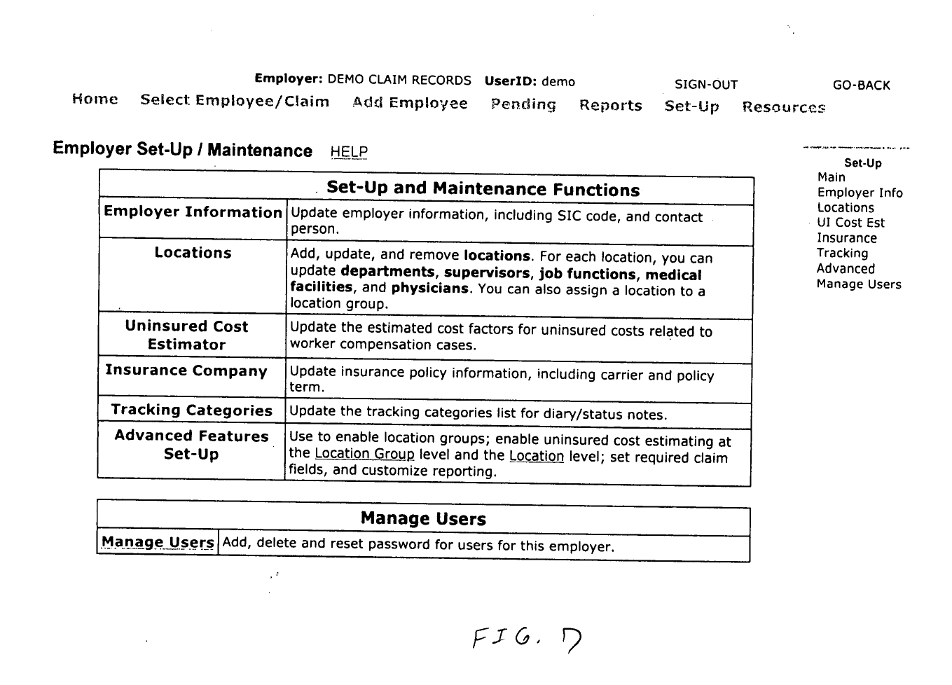

Referring initially to FIG. 1, an uninsured cost estimation system 10 is illustrated in the form of a network block diagram. The system 10 uses a programmed processing system in the form of a conventional web server 12 operating in accordance with an application program 14 and using a memory in the form of a database 16 The web server 12 may take any form. The database 16 may comprise an SQL server database. A user interface 17 enables two groups of users, agents/consultants and employers, represented by work stations 18 and 20, respectively, to interface with the web server 12 via a network, such as the Internet, represented by a line 22, via Internet http messages. HTML, JavaScript and VBScript are used to present user interface screens and to interact with the user interface 17.

The application program 14 implements agent functions 24 and employer functions 26. Generally, the agent functions 24 are available on the agent/consultant's work station 18. Similarly, the employer functions 26 are accessible on the employer's work station 20. As is apparent, the work stations 18 and 20 may comprise any processing system, such as personal computers, suitable for implementing the necessary functionality via the Internet 22. In fact, a single work station could be used, or numerous work stations could be used. The functionality available via the user interfacel 7 is dependent on how a particular user signs into the application program 14, as will be apparent.

Referring to FIG. 2, a block diagram lists top level functions of the application program 14. The top level agent functions are identified as Sign In 28, Manage Employers 29, Employer Claim Access 30, UI Cost Estimator-Master 31, Maintain Master Tables 32 and Manage Agent Users 33. After sign in via the function 28, the remaining functions 29-33 are available to an agent via an appropriate user interface screen 34 for the user interface 17. The top level employer functions 26 include Sign In 36, Online Help 37, Employees/Claims 38, Add Employee 39, Pending 40, Reports/Export 41, Set-Up 42 and Resources 43. As above, the functions 37-43 are available to an employer via the appropriate user interface screen 34 for the user interface 17.

For estimating uninsured costs (also referred to herein as UI costs), the application program 14 uses a worksheet, described below, including financial data used for performing the calculations. The UI Cost Estimator-Master function 31 is used by an agent to set up default values for an employer.

Referring to FIG. 3, a more detailed block diagram of the employer functions 26 is provided. Particularly, sub-functions for Employee/Claims 38, Report/Export 41 and Set-Up 42 are illustrated. Essentially, the sub-functions comprise menu headings used to access program tasks within the application program 14. Not all are discussed in detail herein. With respect to the Employee/Claims function 38, there is included a Locations function 44. As a particular employer may have numerous locations, the employer can set up individual locations and groups of locations to share data and/or use unique data, as necessary or desired. As is apparent, different States have different requirements necessitating consideration of different cost factors. The locations can be individual plants, warehouses, office locations, job sites or any other type of entity to be tracked. A Work Status function 46 is used to keep track of every event associated with the work status of an injured employee. For example, this function is used if a worker has off time, restricted duty or temporary duty due to an injury or an illness. With this function, an employer would enter the start and end date for each period. Pre-defined employee work status categories may be days off lost time, restricted duty, job transfer, temporary, and regular job. A Financial Information function 48 allows an employer to maintain information regarding the financial impact of each specific work-related claim. These include, for example, various insured costs which can be directly input for a particular claim.

The Set-Up function 42 includes a UI Cost Estimator function 50. This is used by an employer to update the master worksheet, referred to initially with respect to FIG. 2 and the agent UI Cost Estimator Master function 31. An Advanced Feature Set-up function 52 is used by the user to set up advance functions such as Location Groups and Cost Levels 53, Location Groups 54, Claim Required Fields 55 and Report Field Names 56.

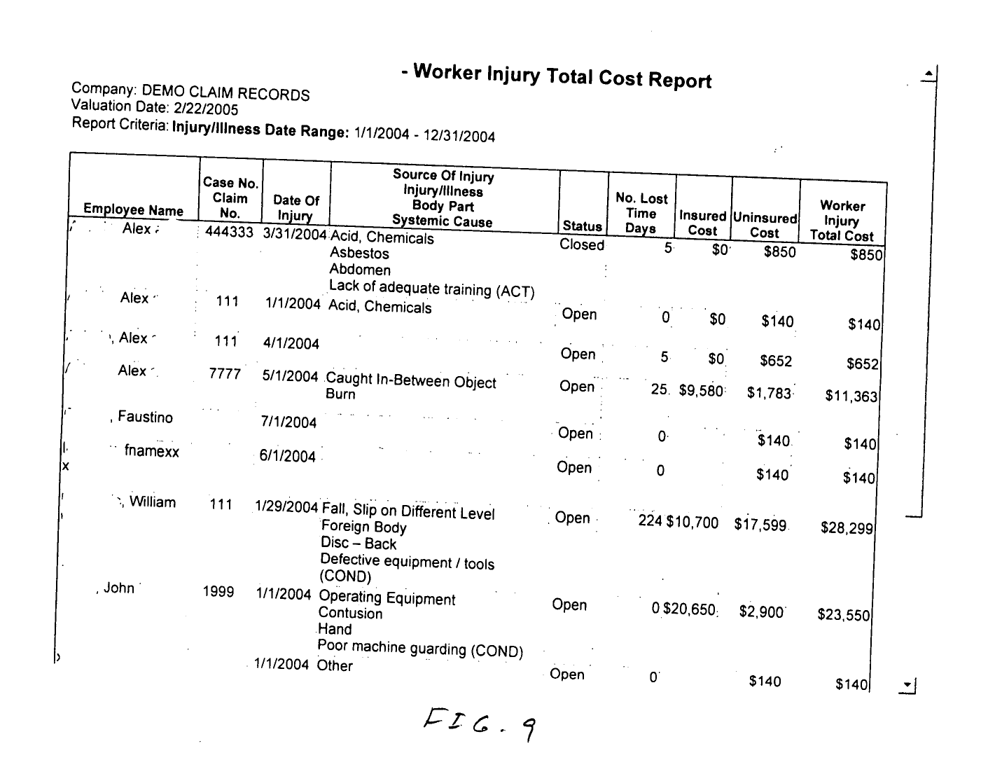

The Report/Export function 41 includes a Worker Injury Total Cost Report function 58. This provides detailed financial loss runs revealing total cost of worker injuries, including both insured costs and uninsured costs. This can include detail from plant to department and supervisor level and includes links from claim lists to view claim detail and updated claim. FIG. 9 illustrates an example of a worker injury total cost report display screen. For any employee and claim, the report includes information such as date of injury, source of injury and status. More particularly, the report shows the number of lost time days and identifies insured costs and uninsured costs to determine worker injury total costs. Particularly, the uninsured costs are determined as described below.

A Best Practice Report can be created that analyzes and benchmarks the effectiveness of responding to a worker injury in the first 48 hours. It has been proven that such a prompt response, if done properly, will dramatically reduce the total cost of worker injuries. Also, a Best Practice Report can be created that analyzes and benchmarks the effectiveness of disability management utilizing a temporary duty (return-to-work) program. It has been proven that such a disability management program will dramatically reduce the total cost of worker injuries.

Referring to FIG. 4, a block diagram illustrates table relationships for uninsured cost processing. The database 16 comprises various tables. The tables are used as resources in calculating costs. Each table is itself a database and may include numerous individual records or files each including select fields. FIG. 4 illustrates how the tables work together and are further referenced in FIG. 5, discussed below. Particularly, each block represents a table having a name indicated in underlining at the top. Within the block, are various fields included in the table. Fields identified with an asterisk are unique to a particular table, in other words can only be changed in that table. Nevertheless, the information in the field can be transferred to another table. Information on fields where the filed data is transferred between tables is illustrated by dash lines connecting the various tables.

The tables include an Agent's table 60 which is related to an Employer's table 62. A UICosts Worksheet table 64 also has a relationship with the Employer's table 62. The Employer's table 62 has a further relationship with a Locations table 66. The Locations table 66 has relationships with an Employee's table 68, a Claims table 70 and a LocGroups table 72. Also, the Employees's table 68 has a relationship with the Claims table 70. The Claims table 70 also has a relationship with a Claims Work Status table 72 which in turn has a relationship with a Work Status table 74.

Referring to FIG. 5, a flow diagram illustrates uninsured cost processing in accordance with the invention. The left-most column illustrates whether the particular step is performed by an agent or an employer. The right-most column indicates a table(s) being used in the particular step. The center column illustrates the particular process step. The process blocks are presented in a logical sequence of functional steps. However, the processing supports ad hoc changes and revisions at each step in the process.

A function block 80 represents the agent updating of the UICosts Worksheet Master table identified as 64 M. As will be apparent, revisions by the master then are used as specific tables identified generically with the numeral 64. This allows the agent to set default values for cost parameters. These default values can be used “as is” by the employer, or the employer can provide its own values.

Function blocks 82, 84, 86, 88 and 90 represent employer set-up functions related to uninsured cost processing. Particularly, function block 82 represents advance features that may not be required. Included in the advance functions are location group settings and cost level settings. The LocGroups field in the Employer's table 62 can be set to zero (off) or one (on). The default is off. The worksheet _locGroups field, also in the Employer's table 62, can be set to off or on. If both locGroups and worksheet locGroups fields are turned on, then location groups will be available as an uninsured cost estimator level. The worksheet _locations field in the Employer's table 62 can be set to off or on. If the worksheet_locations field is turned on, then locations will be available as an uninsured cost estimator level.

The function block 84 represents update of the UICosts_worksheet_level field of the locations table 66. This field can be set to zero for employer level, one for location group level, or two for location level. These are the three uninsured cost estimator levels. The last two levels are available only if the appropriate options were selected in the function block 82.

The function block 86 represents selection of an uninsured cost estimator year. This function includes adding a new year, deleting a year, and selecting a year that was previously added. Adding a new year creates one or more new records in the UICosts worksheet Master table 64 M. The first record for a new year is always the employer level record. Additionally, records are created for each location group and for each location, if applicable. Selecting a year results in the transfer of processing to the function block 88. This function block 88 represents selecting a particular worksheet or record from the UlCost worksheet table 64. If the only uninsured cost estimator level being used by the employer is the employer level, then the function block 88 is bypassed and processing is transferred to the function block 90. The function block 88 is displayed if there are multiple levels available for the year. This function allows the selection of the employer level cost worksheet, one or more location group level cost worksheets and one or more location level cost worksheets. When a cost worksheet is selected in the function block 88, processing is transferred to the function block 90.

The function block 90 allows for update of the UICosts worksheet table 64. The employer can enter values for the cost worksheet or can click “assign industry average estimates” which fills in the values using the master record for the same year. Additionally, if the employer checks the “update uninsured costs on claims” check box, then claim records are updated. The uninsured cost fields are updated in the claim records that use the currently selected record of the UICosts_worksheet table 64.

Claims are selected for update using the following rules:

For an Employer Level cost worksheet, update claims when:
Locations:uicost_worksheet_level=1
and Claims: LocID=Locations: LocID
For a Location Level cost worksheet, update claims when:
Locations:LocID=UICosts_Worksheet:LocID
and Locations:uicost_worksheet_level=2
and Claims: LocID=Locations: LocID
For a Location Group Level cost worksheet, update claims when:
LocGroups:LocGrpID=UICosts_Worksheet:LocGrpID
Locations:LocGrpID=LocGroups:LocGrpID
and Locations:uicost_worksheet_level=3
and Claims:LocID=Locations:LocID

One of the powerful components of the cost estimation system 10 is that it allows the employer to quickly and reliably calculate both the insured and uninsured components that make up the total cost of a worker injury. These calculations are made using the employers financial data and, as a result, the information is very specific to the employers financial performance and costs. Armed with this information the employer can develop focused and effective strategies for slashing the total cost of all its worker injuries. Because corporate resources are finite, this information will allow an employer to more effectively deploy time and financial resources on the critical factors that are driving the total cost of your worker injuries.

In order to accomplish this the cost estimation system 10 uses the UICosts_worksheet table 64. This worksheet is designed to help estimate the “uninsured costs” associated with worker injuries. The financial data is developed one time each year using a cost estimator worksheet. The information in the worksheet is entered into the system 10 at the function block 90. The cost estimation system does the rest. The worksheet consists of six parts, as follows.

Part I Employee Compensation Average Rate

The purpose of this part of the cost estimation system 10 is to identify the average hourly cost of the workforce as a basis for determining this financial impact. These hourly costs drive the calculation of uninsured costs. These costs should include, on an hourly basis: The average wage and salary of all employees; and Employee benefit costs, including all fringe benefits (vacation, sick time, etc.). The “Average Hourly Wage Rate” may be determined by taking the total wages and salaries of all employees budgeted for the coming year and dividing this figure by the number of hours worked in the entire operation. The number of hours worked is calculated as follows:
Total Number of Hours=[#employees]× [40 hrs in a week]×[52 weeks]
The “Average Hourly Benefit Rate” may be determined by taking the employee benefit (including fringe benefits, vacation time, etc.) of all employees budgeted for the coming year and dividing this figure by the number of hours worked in the entire operation. The number of hours worked is calculated as follows:
Total Number of Hours=[#employees]×[40 hrs in a week]×[52 weeks]
Part II Workers Compensation State Specific Parameters

The second step is to define the “offsets” to payments. These “offsets” have to do with the disability payments that the injured employee receives. Each state has workers compensation benefits that vary in three ways. First is the wage-replacement benefit rate. Under workers compensation law the injured employee will receive, normally expressed as a percent of payroll. Next is The Maximum Weekly Wage Replacement Amount. Each state places a maximum on the amount an injured employee can receive in disability benefits irrespective of the wage or salary the employee earns. Finally, waiting period provisions. The provision places a period of time before the disability becomes payable under workers compensation. This waiting period provision acts like a deductible. State laws vary as to whether, once the waiting period provision is reached, the benefits are payable retroactively to the date of injury or not.

The cost estimation system 10 will automatically use this information in offsetting “uninsured costs” by the amount recoverable from an insurance carrier.

Part III Determining The Uninsured Cost Of Medical Only Claims

“Medical only claims” are those claims that require medical treatment only with no lost time. In short, the employee gets prompt medical treatment, either by the company nurse or at an occupational clinic, and returns to work quickly with no lost time. The “uninsured cost” associated with a medical only claim are often overlooked but can quickly add up because they are “frequency” claims. There are several steps in the process of calculating the costs.

In most cases, the employer is asked to estimate the time spent on various activities that make up its Prompt Injury Response. The best way to estimate these costs may be to do one of the following: Conduct a time study. Many companies, as part of their cost accounting process, already are performing time studies on various tasks that are required to manufacture their product or deliver their service. The same methodology can be applied here. Alternatively, informal survey is done by asking the individuals typically involved. This entails determining how much time is spent on each component of the Prompt Injury Response Process for medical only claims.

Each medical only claim requires a basic response that, at a minimum, includes time spent providing first aid to the injured employee, taking the injured employee to the clinic, and completing the Accident Investigation report. The average time spent on these activities is recorded in this section.

Once an employee has reported the medical only claim, has received medical treatment, and the event has investigated, the Claim Coordinator must gather information from the medical provider to verify compensability and then report the injury to the insurance carrier. The average time spent on these activities is recorded in this section.

The Claim Coordinator must also record the event in an OSHA 300 log. The average time for this activity is entered in this section.

Every worker injury claim has what is called the “Ripple Effect” on other individuals in the company. This “Ripple Effect” is caused by one (or more) of four factors: the curiosity factor, departmental impact, up-stream impact, or down-stream impact. The curiosity factor refers to the estimated time that is lost because employees are disturbed by the worker injury and begin to talk about it. Departmental impact relates to the fact that while the employee is off work receiving medical care productivity must continue. However, because an employee is no longer present to do his or her share of the work, the department must adjust. This may require overtime to meet deadlines and production schedules. For companies that are structured vertically so that internal suppliers of component parts or services, called “up-stream suppliers,” are affected. Down-stream impact is the reverse of the “up-stream impact.”

Part IV Determining the Uninsured Cost of Lost-Time on a Per Claim Basis

Lost-time claims involve worker injuries that result in the injured employee not returning immediately after medical treatment. The injured employee may have been disabled by the injury and will be off work until medically released to do so. In Part IV the employer will consider the impact of the lost-time injury event on operational productivity as opposed to administrative activity. These costs are the equivalent of “fixed costs” in that they are incurred irrespective of the length of disability. There are “variable costs” associated with a disability claim and these will be estimated in Part VI.

The employer will estimate the time spent on various activities that make up its Prompt Injury Response and Disability Management Programs. The best way to estimate these costs is to conduct a time study or do an informal survey. Many companies, as part of their cost accounting process, already are performing time studies on various tasks that are required to manufacture their product or deliver their service. The same methodology can be applied here. An informal survey can be conducted by asking the individuals typically involved. This would entail going to the Claim Coordinator, Safety Director, and representative Supervisors who are involved with the bulk of worker injury claims and asking them how much time they spend on each component of lost-time claims.

As with the case of medical only claims, there is time spent in the Prompt Injury Response process. This includes the time spent providing medical attention, time spent taking the employee to and from the clinic, and the time spent investigating the accident. The time spent on these activities is typically longer than a medical only claim.

Again, as with a medical only claim, there is usually a “Ripple Effect” that results from a disability injury. However, the “Ripple Effect” is usually greater and more widespread with a disability claim. The “Ripple Effects” in Part IV have two major components. Additional time is incurred with hiring and training replacement workers. Because the injured employee is off work for at least five (5) days, it is not uncommon to hire temporary workers to continue the work. This will involve cost in the hiring process itself and well as training. There is also a curiosity factor. Typically, when an employee is seriously injured, the knowledge of the event runs quickly through the department and the entire facility. Employees take time to talk about the event. Some may be emotionally affected. As a result, productivity is affected.

Workers compensation system pays disability benefits to workers who are injured on the job. However, there is a waiting period before benefits are paid. These were determined in Part II, above. The determination of non-reimbursed compensation section calculates the costs that an employer will incur during the waiting period provision of the worker compensation act. It is calculated automatically by the cost estimation system 10 based on total wage data indicated in Part I and the waiting period provision indicated in Part II.

In order to allow for maximum flexibility and credibility, the cost estimation system 10 has two fields that can be used to add other categories of loss specific to the employer's operation. This should be other “fixed costs'incurred irrespective of the length of the disability. For each category the employer describes the category and the estimated hours expended in each category.

Part V Determining Lost Time Costs —Per Lost Time Period

The second “fixed” component of a disability injury has to do with costs associated with the administration of the claim. There will be an enormous amount of time spent by Claim Management personnel throughout the claim process. Examples of such costs include: Average time spent evaluating medical information provided by the healthcare provider(s) to determine compensability; Average time spent reporting the claim to the insurance adjuster; Average time spent identifying temporary duty tasks that are medically approved, ADA compliant, and match the injured employee's work limitations; Average time spent recording and up-dating the OSHA 300 log; and Average time spent training the injured employee while on Temporary Duty or restricted duty status.

As with the medical only claim, there is a cost associated with interfacing with the many healthcare providers involved with the lost-time claim and with the insurance company adjuster.

The cost of complying with OSHA record keeping requirements must be determined. Recording a disability claim in an OSHA log, and updating this record, is a complex task. Also, there will be forms required to comply with the Family Medical Leave Act, and other Federal and state regulations. All of this time was triggered by the worker-injury claim and should rightly be accounted for in the cost estimation system 10. As above there may also be ripple effects. Depending on the administrative costs incurred as result of the average disability injury, there may be other costs to be captured. For each category the employer will describe the category and the estimated hours expended with each category.

Part VI Determining the Variable, Uninsured Cost of Lost-Time Claims

Parts IV and V were designed to estimated the “fixed, uninsured costs” of a disability injury. These costs are “fixed” because they are incurred irrespective of the length of disability. There is an additional set of costs that are “variable” in nature. They tend to accumulate over the length of the lost-time claim. The longer the claim the greater the “variable” cost. These “variable” costs can be significant and reflect the true disruption within your facility from a major work-related injury. These “variable” costs are both operational and administrative in nature.

Depending on the nature of the worker injury, the variable costs associated with the “Ripple Effects” can be significant. There are the components of these “Ripple Effects.” The injured employee may be off of work for an extended period of time. At some point the employer is going to have to address the loss of production created by this event. This may entail overtime by existing employees in the department. A new employee may be hired on a full time basis. The long-term loss of an employee may not only affect the departmental productivity, it may also affect “up-stream” suppliers of in-process product or service. Because the department in which the injury occurred is producing less efficiently, its need for in-process product or service may be disrupted. This in turn will affect to an extent the productivity efficiency of the supplying department. Down-stream impact is the same as above but the impact is on the down-stream recipient of products or services produced by the department in which the claim occurred. This, in turn, will affect the productive efficiency of the down-stream department or area of operation.

Next, the employer will determine variable costs associated with claims administration. Particularly for lost-time disability claims, the Claim Coordinator's time could be quite extensive. An incredible amount of time is typically spent with all the people involved with the claim —the employee, the insurance company, the healthcare providers, and the attorneys.

The variable, uninsured compensation costs associated with disability claims must be calculated. Even though the injured employee is receiving disability benefits from the workers compensation system, very often these benefits do not equal their total wages and other benefit costs. Because these costs are normally still paid to the injured employee, and because the benefit costs are now being paid for an unproductive employee, these costs can arguably be included in the “uninsured cost” of the worker injury.

The following uninsured wage-costs are captured by the cost estimation system after the waiting period begins and only if the employee is completely off work. They do not apply if the employee is back at work in a temporary duty or restricted duty. Employee benefit costs are calculated based on the employee benefit wage rate indicated in Part I and multiplied by 40 hours in a work week. Wage differential costs are the differential between the average hourly wage rate and insured disability benefit allowed by the state workers compensation system. There are also uninsured wages over the maximum Weekly Wage Replacement Amount. Most states limit disability benefits to a specific amount or period of time. Even though the employee may be off longer than benefits are available, the employer may still pay their wages.

Although the above sections identify most of the common variable cost categories that will be encountered, a particular employer may identify other items. These can include any other “variable claim costs” that are normally incurred as a result of a lost time injury.

Once setup has been completed at the function block 90, the employer can begin to utilize the cost estimation system 10 to estimate uninsured costs for an injured employee. In the function block 92 the claim add/update process begins. The user interface 17 provides for selecting an existing claim or adding a new claim. The UlCost calculations for a claim are managed the same for a new claim as for update of an existing claim. When a claim is selected or new claim is added, then the claimed value of the claims record is passed to each of claim update screens.

The function block 94 provides for claim update of UI Cost related claim fields. The Case Information claim update function allows for update of the locid field of the Claims table 70. The claims:locid field defaults to the employee record locid value. The user can click the “Click Here” after the “To change the employee's work location at the time of the injury/illness” text to modify the default assignment. For calculating uninsured costs for the claim, the claims:locid field is used to determine which location record to use, and in turn, the location record determines which UICosts_Worksheet record will be used. The claims:locid field stores the employment location at the time of illness/injury. Uninsured costs are recalculated for the claim whenever this claims:locid field changes.

The Employee Work Status Tracker function allows for update of the work status periods that are stored in the Claim_WorkStatus table 72. Each work status period for the claim is entered by the user. For each work status period, startdate, enddate, and workstatusID (Off Work-1, Work Restriction-2, Work Transfer-3, and Regular Job-4) are stored in a Claim_WorkStatus record. Additional, the claim type—Medical Only (MO) or Lost Time (LT) —is stored in the claims:HC_MO_LT field. Uninsured costs are calculated differently for MO and LT claims. Number of lost time periods, workstatus of each lost time period, and total number of days of lost time are used for calculating uninsured costs for a Lost Time claim. Claims:losttime_days is recalculated whenever the claim_workstatus records are updated by the user. When calculating claims:losttime_days, if there is no enddate for a work status period, then the current date is used. Additionally, uninsured costs are recalculated for the claim whenever the claim workstatus records are updated by the user.

The function block 96 provides for claim update of claim Financial Information through the user interface 17. This screen allows for entry of additional claim costs and override of the variable uninsured costs for a claim. Uninsured costs and total claim costs are recalculated for the claim whenever the user enters a change to this screen.

The function block 98 provides for reporting and export through a user interface.

To update the claims records at the function blocks 94 and 96, two stored procedures are called. One determines duration of the work status information entered for the particular claims. The other calculates costs of a claim by applying the estimated cost factors entered above to the durations of work status to estimate uninsured costs for the injured employee. The stored procedures are referred to as
1. Stored Procedure: updt_vLT_LostDays_calc_NEW
2. Stored Procedure: updt_Uninsured_Total_HC_Cost_NEW

The logic for the two stored procedures is as follows:

```
Stored Procedure: updt_vLT_LostDays_calc_NEW
Parameter usage:
CLAIMED - if not null, calculate lost days for one claim
YEAR - if not null, calculate lost days for all claims in YEAR for the employer
ENID - required if CLAIMED is null
FORCERECALC - values are 1 (true) and 0 (false). Forces a recalculation of lost days. If value is
false (0), then lost days are recalculated for a claim only if there is a claim_workstatus record for
the claim where the enddate value is null. This is a performance consideration -- eliminating the
need to recalculate lost days unnecessarily. FORCERECALC is true when calling process is
claim Temporary Duty update, otherwise FORCERECALC is false.
RETURNLOSTDAYS - values are 1 (true) and 0 (false). Used only for update of one claim. If
the value is true then the stored procedure returns the calculated lost days to the calling process.
Constants:
DAYSPERWEEK = 5/7
CURRENTDATE = Current Date
Lost days can be calculated at the following levels:
  1) claim 2) employer year
The following claims record fields are updated by this procedure:
UICost days: lost time, off work, temp duty, work restrictions
OSHA days: off work, temp duty, work restrictions
Period Counts: off work, temp duty, work restrictions
Step 1. Create a temporary table #tsel to store CLAIMED's for the claims selected. Select claims
either for one claim or for all the claims for one year for one employer. Use the following rules
for selecting claims:
>>> select one claim
If CLAIMED is not null then
  select CLAIMED
>>> select all of the claims for one employer, for one year
If YEAR is not null
  select all claimed from the Claims table
  where the claim record belongs to the ENID (Employer ID)
  and the year of the Injury Date is YEAR
Step 2. Create a temporary table #tsel2 to store the claimed for the claims selected in Step 1,
where lost days should be recalculated. Use the following rules:
>>> calculate lost time only for claims where the lost time period has not ended
If FORCERECALC = 0
  select all claimed from the #tsel table
  where the claim has a Claim_Workstatus record
  and the WorkStatus is type Lost Time
  and End Date of the workstatus period is null
>>> calculate lost days for all claims in the #tsel table
if FORCERECALC = 1
  select claimed from the #tsel table
Step 3. Create a temporary table #t. For claims selected in table #tsel2, calculate days lost, osha
Off Work days, osha Restricted Duty days, and store the results in #t.
For this step, use the following workstatus records:
WorkStatusID  WorkStatus
1  Off Work
2  Work Restriction
3  Work Transfer (Temporary)
Join the tables claim_workstatus, workstatus, and #tsel2. For each claim record, use current date
if end date is null, select the claim_workstatus records where Lost Time = 1 (off work), perform
the following calculations, sum the result for each claim record, and store the result in table #t:
temp duty days = 1 + enddate − startdate
if workstatusid = 1 then
  osha Off Work days = 1 + enddate − startdate
if workstatusid = 2 then
  osha Restricted days = 1 + enddate − startdate
if workstatusid = 3 then
  osha Temp Duty days = 1 + enddate − startdate
Step 4. Calculate UICost days using the #t table:
UICost Lost Days = days lost * DAYSPERWEEK
UICost offwork = Osha offwork days * DAYSPERWEEK
UICost restricted = osha restricted days * DAYSPERWEEK
UICost tempduty = Osha tempduty days * DAYSPERWEEK
Step 5. Update the claims table, joining it with the #t table (on claimed):
Update UICost days fields
Update osha days fields
Step 6. Create a temporary table #periods with work fields for calculating period counts.
Step 7. Join the tables claim_workstatus, workstatus, and #tsel2, and insert into the #periods
table. Group the joined tables by claimed, and count the periods for each workstatusid (1,2, and
3).
Step 8. Update the claims table, joining with the #periods table (on claimed):
Update the period count fields
Step 9. Initialize the lost time fields in the Claims record to zero, if no lost time periods exist.
Do this by joining the claims table with the #tsel table (on claimed) and select records where
there is no #t record matching on claimed.
Step 10. If RETURNLOSTDAYS = 1, then return lost time days from claims where claimed =
CLAIMED.
Stored Procedure: updt_Uninsured_Total_HC_Cost_NEW
Parameter usage:
CLAIMED - used only if calculating costs for one claim
YEAR - required for all levels except for the claim level.
ENID - used only when calculating costs for all claims in @year for employer.
LOCID - used only when calculating costs for all claims in @year for one location.
LOCGRPID - used only when calculating costs for all claims in @year for one location group.
Constants:
WORKHRSPERDAY = 8
DAYSPERWEEK = 5/7
WYEAR = YEAR
If CLAIMED is not null then
  WYEAR = year of the injury for the claim
Claims record UI cost fields can be recalculated at four levels:
1) claim 2) location 3) location group 4) employer
Locations and claims are selected based on the parameters values. A stored procedure cursor
processes one location at a time. For each location processed: 1) the appropriate cost worksheet
is retrieved, 2) claims are retrieved into a temporary table, 3) claim costs are calculated, 4) the
cost results are stored in the claim records.
Step 1: Create a temporary table, #t2a, containing locgrpid, uicost_worksheet_level, locid, and
claimed. Select data from the claims, employees, and locations tables. Use the following rules:
If CLAIMED is not null
  Select from the location, employees, and claims records
  where claimed = CLAIMED
if ENID is not null
  Select from the location, employees, and claims records
  where enid = ENID and injury year = YEAR
if LOCGRPID is not null
  Select from the location, employees, and claims records
  where locgrpid = LOCGRPID and injury year = YEAR
if LOCID is not null
  Select from the location, employees, and claims records
  where locid = LOCID and injury year = YEAR
Step 2:
Select non-duplicate records from table #t2a and insert these records into the #CursorTbl2 table
and read each record from #CursorTbl2
Step 2a:
For each location in #CursorTbl2, process as follows:
Create a temporary table, #worksheet3, to hold the UICost Worksheet cost fields for the current
#CursorTbl2 record using the following rules:
Set wERID, wLOCID, wLOCGRPID, wUICOST_WORKSHEET_LEVEL to the current
#CursorTbl2 field values.
Store all of the fields from UICosts_Worksheet in a new #worksheet3 record. Use the
UICOST_WORKSHEET_LEVEL field in the #CursorTbl2 table to determine which record to
retrieve from UICosts_Worksheet:
if wUICOST_WORKSHEET_LEVEL = 1
  select the uicosts_worksheet record
    where enid = wERID and year = YEAR and worksheetlevel = 1
if @uicost_worksheet_level = 2
  select the uicosts_worksheet record
    where locgrpid = wLOCGRPID and year = YEAR and worksheetlevel = 2
if @uicost_worksheet_level = 3
  select the uicosts_worksheet record
    where locid = wLOCID and year = YEAR and worksheetlevel = 3
Next, create a temporary table, #claims1, to hold claim fields, UI cost calculation work fields,
and UI cost fields. Insert into the #claims table one record for each claims table record for the
current year and current location being processed.
Use the following selection rule to insert records into the #claims table:
select claim fields, uicost fields, and uicost work fields
  from the tables claims, #cursorTbl2, and #t2a
  joining the tables on the fields uicost_worksheet_level, locgrpid, locid, and claimed
Calculate #claims1 fields, using #claims1 fields and #worksheet3 fields:
>>> Calculate wait days:
if UICost_OffWork_Days < UI_WageReplaceWaitDays then
  UICost_OffWork_Wait_Days = UICost_OffWork_Days
if UICost_OffWork_Days >= UI_WageReplaceWaitDays then
  UICost_OftWork_Wait_Days = UI_WageReplaceWaitDays
>>> Calculate wage replacement days:
if LtPer_OffWork_PerCnt > 0 and UICost_OffWork_Days > UICost_OffWork_Wait_Days then
  UICost_OffWork_WageRe_Days = UICost_OffWork_Days − UICost_OffWork_Wait_Days
>>> Calculate medical only total amount:
if LtPer_Total_PerCnt = 0 then
  MO_TotalAmt = mo_totalamt
>>> Set LtClm_TotalAmt, LtPer_TotalAmt, and LtRec_TotalAmt equal to base amounts
if LtPer_Total_PerCnt > 0 then
  LtClm_TotalAmt = LtClm_BaseAmt
  LtPer_TotalAmt = (LtPer_BaseAmt * LtPer_Total_PerCnt),
  LtRec_TotalAmt = ( (LtRec_BaseAmt / 5) * UICost_LostTime_Days )
>>> Calculate LTClm_WaitPerCompAmt
if LtPer_OffWork_PerCnt > 0 then
  LTClm_WaitPerCompAmt = (UICost_OffWork_Wait_Days * @WORKHRSPERDAY) *
UI_AvgCompPerHr
>>> Calculate LtClm_TotalAmt
if LtPer_OffWork_PerCnt > 0 then
  LtClm_TotalAmt = LtClm_TotalAmt + LTClm_WaitPerCompAmt
>>> Calculate LTPer_Rip_HirePlaceHrs; apply only to one period (this is really an LtClm cost)
if c.LtPer_Total_PerCnt > 0 and ynhirereplaceworkers = 1
  LtClm_TotalAmt = LtClm_TotalAmt + (LTClm_Rip_HireReplaceHrs * UI_AvgCompPerHr)
>>> Calculate restricted duty cost; for each period
if LtPer_Restricted_PerCnt > 0
  LtPer_TotalAmt = LtPer_TotalAmt + (LTPer_Rip_TrainRestrictedHrs * UI_AvgCompPerHr *
LtPer_Restricted_PerCnt)
>>> Calculate temp duty cost; for each period
if LtPer_TempDuty_PerCnt > 0
  LtPer_TotalAmt = LtPer_TotalAmt + (LTPer_Rip_TrainTempHrs * UI_AvgCompPerHr *
LtPer_TempDuty_PerCnt)
>>> Calculate UICost_LostTime_Days_Rip_MaxDays
if LtPer_Total_PerCnt > 0 and LTRec_Rip_MaxDays > 0
    and LTRec_Rip_MaxDays < UICost_LostTime_Days_Rip_MaxDays
  UICost_LostTime_Days_Rip_MaxDays = LTRec_Rip_MaxDays
>>> Start calculate LTRec_Rip_TotalAmt (using UpstreamHrs + DownstreamHrs)
if LtPer_Total_PerCnt > 0
  LTRec_Rip_TotalAmt =
  ( ( ( ( LTRec_Rip_UpstreamHrs + LTRec_Rip_DownstreamHrs ) *
  UI_AvgCompPerHr ) / 5) * UICost_LostTime_Days_Rip_MaxDays )
>>> Finish calculate LTRec_Rip_TotalAmt (using LtRec_Rip_DeptAmt)
if LtPer_Total_PerCnt > 0
  LTRec_Rip_TotalAmt = LTRec_Rip_TotalAmt +
  ( ( ( LtRec_Rip_DeptAmt ) / 5) * UICost_LostTime_Days_Rip_MaxDays )
>>> Calculate LtRec_TotalAmt
if LtPer_Total_PerCnt > 0
  LtRec_TotalAmt = LtRec_TotalAmt + LTRec_Rip_TotalAmt
>>> Calculate LTRec_UIComp_BenefitsAmt
if LtPer_Total_PerCnt > 0
  LTRec_UIComp_BenefitsAmt = (UI_AvgBenefitPerHr * @WORKHRSPERDAY *
UICost_OffWork_WageRe_Days)
>>> Calculate LTRec_UIComp_WageDiffAmt
if LtPer_Total_PerCnt > 0
  LTRec_UIComp_WageDiffAmt = (UI_AvgWagePerHr * @WORKHRSPERDAY *
UICost_OffWork_WageRe_Days *
  (1 − UI_WageReplacePct/100) )
>>> Start calculate LTRec_UIComp_OverMaxWageRe
if LtPer_OffWork_PerCnt > 0 and UI_WageReplaceMaxAmt > 0
  LTRec_UIComp_OverMaxWageRe =
  (UI_AvgWagePerHr * @WORKHRSPERDAY * UICost_OffWork_WageRe_Days *
(UI_WageReplacePct/100) )
  − ( (UI_WageReplaceMaxAmt / 5) * UICost_OffWork_WageRe_Days)
>>> Finish calculate LTRec_UIComp_OverMaxWageRe − check for negative amount
if LTRec_UIComp_OverMaxWageRe < 0
  LTRec_UIComp_OverMaxWageRe = 0
>>> Calculate LtRec_TotalAmt
if LtPer_Total_PerCnt > 0
  LtRec_TotalAmt = LtRec_TotalAmt + LTRec_UIComp_BenefitsAmt +
LTRec_UIComp_WageDiffAmt +
LTRec_UIComp_OverMaxWageRe
>>> Calculate UICost_VarUIAmt
if UICost_VarUIAmt_Ovr is not null
  UICost_VarUIAmt = UICost_VarUIAmt_Ovr
if UICost_VarUIAmt_Ovr is null
  UICost_VarUIAmt = LtPer_TotalAmt + c.LtRec_TotalAmt
>>> Calculate UICost_VarUIAmt_calc
UICost_VarUIAmt_calc = c.LtPer_TotalAmt + c.LtRec_TotalAmt
>>> Calculate UICost_TotalAmt
UICost_TotalAmt = c.mo_totalamt + c.ltClm_totalamt + UICost_VarUIAmt
```

Next, update the cost fields in the claims records, using #claims records created above.
This completes Step 2a processing for one location. Step2a is repeated for each location being processed.

Referring to FIG. 6, a block diagram summarizes the update process for the cost fields of the Claims table 70. The claim-specific fields (insured costs and claim-specific uninsured costs) are updated through the Update Claims: Financial Information function block 96, see also FIG. 5. The lost days summary fields are updated by the first stored procedure updt_vLT_LostDays_calc_NEW at a block 100. The UI Cost calculated fields are updated by the second stored procedure updt _Uninsured_Total_HC_Cost_NEW at a block 102.

The stored procedure updt _vLT_LostDays _calc _NEW is executed after each of the following screen updates by the user:
Update Claim: Financial Information block 96;
Update Claim: Work Status function 72; and
Employer Set-Up: UI Cost Estimator —Worksheet Update 90 (Update UI Costs on Claims checked).

The stored procedure updt_Uninsured_Total_HC_Cost_NEW is executed after each of the following screen updates by the user:
Update Claim: Case Information —Employment Location function 66;
Update Claim: Work Status function 72;
Update Claim: Financial Information function 96; and
Employer Set-Up: UI Cost Estimator —Worksheet Update 90 (Update UI Costs on Claims checked).

FIG. 7 illustrates a user display during employer set-up or maintenance. This is displayed when a user begins to set up administrative functions. It is used to enter and/or update employer information, location and the estimated cost factors for uninsured costs related to worker compensation cases, as discussed above. This is the portion of the system that drives the determination of estimatead hidden costs.

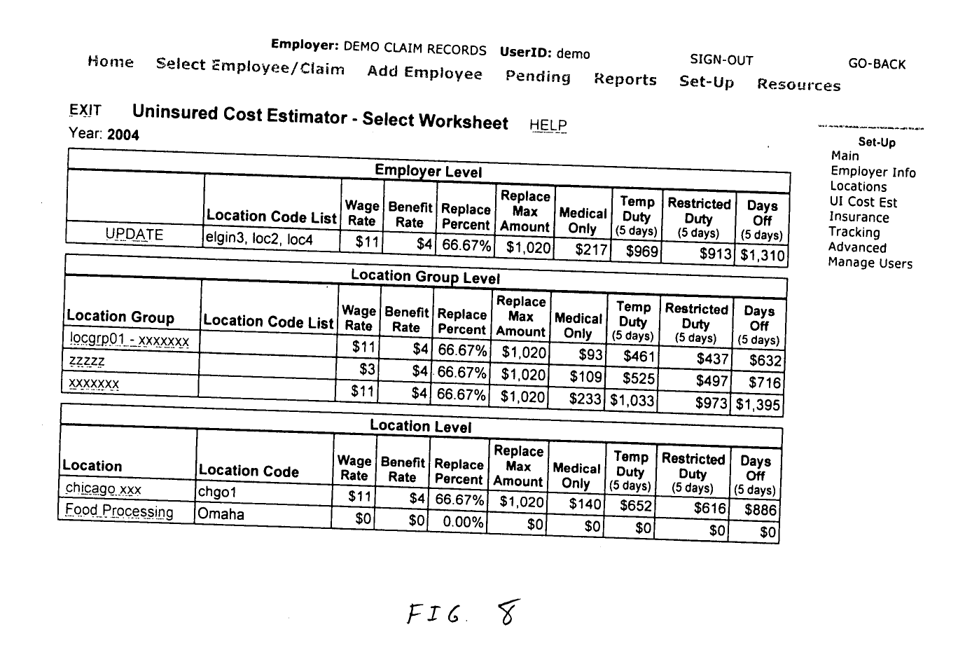

FIG. 8 is a display that illustrates locations that were defined in the employer level, location group level and location level.

As discussed above, FIG. 9 illustrates the report generated for claim records which summarizes for individual claims the insured costs, uninsured costs and total worker injury costs.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, in accordance with the invention there is described a system and method which estimates uninsured cost by determining durations of work status information from claim data and calculating costs of a claim by applying estimated cost factors to durations of work status to estimate uninsured costs for an injured employee.

I claim:

1. An uninsured cost estimation method comprising:
storing a database of estimated cost factors for uninsured costs related to workers compensation claims;
entering claim data relating to an injured employee including work status information selected from lost work time, restricted duty work time, job transfer time and return to work; and
operating a processing system to estimate uninsured costs comprising determining durations of the work status information from the claim data and calculating costs of a claim by applying the estimated cost factors to the durations of work status to estimate uninsured costs for the injured employee.

2. The uninsured cost estimation method of claim 1 wherein the estimated cost factors are selected from the group consisting of employee average compensation rate, workers compensation parameters, uninsured costs of medical claims, uninsured costs of lost time for a claim, lost time costs for a select time period, and variable uninsured costs of a lost time claim.

3. The uninsured cost estimation method of claim 1 further comprising generating a report showing the estimated uninsured costs for the injured employee.

4. The uninsured cost estimation method of claim 1 wherein entering claim data relating to an injured employee further comprises entering insured cost amounts for the injured employee.

5. The uninsured cost estimation method of claim 4 further comprising generating a report showing total worker injury costs for the injured employee including insured cost amounts and the estimated uninsured costs.

6. The uninsured cost estimation method of claim 1 wherein claim data is entered on a remote processor connected to the processing system via a network.

7. The uninsured cost estimation method of claim 1 wherein the database of estimated cost factors for uninsured costs related to workers compensation claims comprises a plurality of tables for different locations and years.

8. An uninsured cost estimation system comprising:
memory means for storing estimated cost factors for uninsured costs related to workers compensation claims;
input means for entering claim data relating to an injured employee including work status information selected from lost work time, restricted duty work time, job transfer time and return to work; and
a programmed processing system associated with the memory means and the input means and operated in accordance with a program to estimate uninsured costs comprising determining durations of the work status information from the claim data and calculating costs of a claim by applying the estimated cost factors to the durations of work status to estimate uninsured costs for the injured employee.

9. The uninsured cost estimation system of claim 8 wherein the estimated cost factors are selected from the group consisting of employee average compensation rate, workers compensation parameters, uninsured costs of medical claims, uninsured costs of lost time for a claim, lost time costs for a select time period, and variable uninsured costs of a lost time claim.

10. The uninsured cost estimation system of claim 8 further comprising means for generating a report showing the estimated uninsured costs for the injured employee.

11. The uninsured cost estimation system of claim 8 wherein the input means is also operative to enter insured cost amounts for the injured employee.

12. The uninsured cost estimation system of claim 11 further comprising means for generating a report showing total worker injury costs for the injured employee including insured cost amounts and the estimated uninsured costs.

13. The uninsured cost estimation system of claim 8 wherein the input means comprises a remote processor connected to the programmed processing system via a network.

14. The uninsured cost estimation system of claim 8 wherein the database of estimated cost factors for uninsured costs related to workers compensation claims comprises a plurality of tables for different locations and years.

15. An uninsured cost estimation system comprising:
a database for storing estimated cost factors for uninsured costs related to workers compensation claims;
a user workstation for entering claim data relating to an injured employee including work status information selected from lost work time, restricted duty work time, job transfer time and return to work; and
a programmed processing system operatively connected to the database and communicating with the user workstation over a network, the programmed processing system operating in accordance with a program to estimate uninsured costs comprising determining durations of the work status information from the claim data and calculating costs of a claim by applying the estimated cost factors to the durations of work status to estimate uninsured costs for the injured employee.

16. The uninsured cost estimation system of claim 15 wherein the estimated cost factors are selected from the group consisting of employee average compensation rate, workers compensation parameters, uninsured costs of medical claims, uninsured costs of lost time for a claim, lost time costs for a select time period, and variable uninsured costs of a lost time claim.

17. The uninsured cost estimation system of claim 8 wherein the user workstation is also operative to enter insured cost amounts for the injured employee.

18. The uninsured cost estimation system of claim 17 wherein the programmed processing system comprises a report program for generating a report showing total worker injury costs for the injured employee including insured cost amounts and the estimated uninsured costs.

19. The uninsured cost estimation system of claim 15 wherein the database of estimated cost factors for uninsured costs related to workers compensation claims comprises a plurality of tables for different locations and years.
